(19) United States
(12) Patent Application Publication
(10) Pub. No.: US 2023/0063213 A1
(43) Pub. Date: Mar. 2, 2023

(54) IMAGE OBJECT LABELING METHOD, SYSTEM AND COMPUTER READABLE MEDIUM

(71) Applicant: Footprintku Inc., Kaohsiung City (TW)

(72) Inventors: Yan-Jhih WANG, Kaohsiung City (TW); Chia-Ying HSIEH, Kaohsiung City (TW); Yu-Siang FAN JIANG, Kaohsiung City (TW); Tzung-Pei HONG, Kaohsiung City (TW); Shih-Feng HUANG, Kaohsiung City (TW)

(21) Appl. No.: 17/463,816

(22) Filed: Sep. 1, 2021

(51) Int. Cl. G06K 9/00; G06K 9/38; G06K 9/46; G06T 5/30; G06K 9/62

(52) U.S. Cl. CPC G06K 9/00456; G06K 9/38; G06K 9/4609; G06K 9/00463; G06T 5/30; G06K 9/00476; G06K 9/6256; G06N 5/022

(57) ABSTRACT

An image object labeling method and system are disclosed. The method is executed by a processor coupled to a memory and includes providing an image file; detecting at least one first object on the image file and generating at least one graphic block and attribute thereof; performing a binarization process to present a first graphic feature on a region containing the graphic block in the image file and a second graphic feature on the rest region; combining the results of detecting and the binarization process, and filtering the image file through several gradually reduced masks to show several separated graphic components until number of the separated graphic components and the at least one graphic block are the same; and assigning a label to the separated graphic components according to the attribute, alternatively, outputting a message, receiving a command for adjusting the graphic block and attribute thereof, as the labels.

### FIELD OF INVENTION

The present disclosure relates to a labeling technology and, specifically to an image object labeling method and system.

### BACKGROUND OF INVENTION

The development and application of machine learning have gradually become an apparent trend. A large amount of data can be used to train machine learning model and the trained models can be used to obtain certain prediction information.

In fact, for a machine learning model with strong generalization, it is necessary to collect a large amount of data with relatively even category differences to complete a training process. A digital file containing a specific image category is taken as an example; the data collecting process needs to select data, assign labels, and confirm correctness.

Generally, to adapt to changes in the application context of machine learning, it is necessary to adjust the given types of data labels specifically manually. However, because judgment factors, such as experience, cognition, and rules, are different from person to person, in addition to labeling errors of data labels, the quality of the data set can be different, and the construction efficiency of the machine learning model will be affected. Although some labeling technologies have been proposed in the past, they still need to be improved.

In light of this, it is necessary to provide a technical solution different from the past to solve a prior art problem.

### SUMMARY OF INVENTION

One objective of the present disclosure is to provide an image object labeling method that can provide labels on image objects and is favorably suitable for improving label construction efficiency of a machine learning model.

Another objective of the present disclosure is to provide an image object labeling system that can provide labels on image objects and is favorably suitable for improving label construction efficiency of a machine learning model.

Another objective of the present disclosure is to provide a tangible, non-transitory, computer readable medium that can provide labels on image objects and is favorably suitable for improving label construction efficiency of a machine learning model.

To achieve the above objective, one aspect of the present disclosure provides an image object labeling method, executed by a processor coupled to a memory, including: providing an image file; detecting at least one first object from the image file, and generating at least one graphic block and attribute thereof according to a first detection result; performing a binarization process on the image file, to present a first graphic feature on a region containing the graphic block in the image file and present a second graphic feature on the rest region, in the image file; combining the first detection result and a result of the binarization process, and filtering the image file through a plurality of masks whose are gradually reduced to show a plurality of separated graphic components on a portion of the first graphic feature until a number of the separated graphic components is the same as a number of the at least one graphic block; and assigning a label to each of the separated graphic components according to the attribute of the at least one graphic block, alternatively, outputting a message, receiving a command, and adjusting the at least one graphic block and attribute thereof as the label according to the command.

In one embodiment of the present disclosure, after generating the at least one graphic block and attribute thereof, the method further includes: detecting at least one second object from the image file, and generating at least one text block and attribute thereof according to a second detection result.

In one embodiment of the present disclosure, the image object labeling method further includes: processing the at least one graphic block and the at least one text block by a filling algorithm.

In one embodiment of the present disclosure, before performing the binarization process, the method further includes: performing a grayscaling process on the at least one graphic block and the at least one text block.

In one embodiment of the present disclosure, the image object labeling method further includes: processing the region presenting the second graphic feature by a dilation algorithm or an erosion algorithm.

In one embodiment of the present disclosure, the label includes a pattern, a text, or a combination thereof.

In one embodiment of the present disclosure, the at least one graphic block includes a partial feature diagram of an electronic component, and the attribute of the graphic block includes a directional attribute.

Another aspect of the present disclosure provides an image object labeling system including a processor coupled to a memory storing instructions configured to be executed by the processor to perform the above method.

Another aspect of the present disclosure provides a tangible, non-transitory, computer readable medium including instructions stored in a tangible non-transitory computer-readable medium to perform the above method.

The image object labeling method, system, and tangible non-transitory computer readable medium of the present disclosure are provided for providing an image file; detecting at least one first object from the image file, and generating at least one graphic block and attribute thereof according to a first detection result; performing a binarization process on the image file, to present a first graphic feature on a region containing the graphic block in the image file and present a second graphic feature on the rest region, in the image file; combining the first detection result and a result of the binarization process, and filtering the image file through a plurality of masks whose are gradually reduced to show a plurality of separated graphic components on a portion of the first graphic feature until a number of the separated graphic components is the same as a number of the at least one graphic block; and assigning a label to each of the separated graphic components according to the attribute of the at least one graphic block, alternatively, outputting a message, receiving a command, and adjusting the at least one graphic block and attribute thereof as the label according to the command. Thus, after the label creation process mentioned above, the image objects are labeled. It can greatly shorten creation time of labeling objects, and is beneficial to improve the label construction efficiency of the data set for the development and application of the machine learning model.

### BRIEF DESCRIPTION OF DRAWINGS

FIG. 1 is a schematic diagram of an image object labeling system according to some embodiments of the present disclosure.

FIG. 2 is a flow chart of an image object labeling method according to some embodiments of the present disclosure.

FIG. 3A is a schematic diagram of a first-phase of labeling image objects according to some embodiments of the present disclosure.

FIG. 3B is a schematic diagram of a second-phase of labeling image objects according to some embodiments of the present disclosure.

FIG. 3C is a schematic diagram of a third-phase of labeling image objects according to some embodiments of the present disclosure.

FIG. 3D is a schematic diagram of a fourth-phase of labeling image objects according to some embodiments of the present disclosure.

FIG. 3E is a schematic diagram of a fifth-phase of labeling image objects according to some embodiments of the present disclosure.

FIG. 3F is a schematic diagram of a sixth-phase of labeling image objects according to some embodiments of the present disclosure.

FIG. 3G is a schematic diagram of a seventh-phase of labeling image objects according to some embodiments of the present disclosure.

FIG. 3H is a schematic diagram of an eighth-phase of labeling image objects according to some embodiments of the present disclosure.

FIG. 4 is a schematic diagram of an example of ideal positions of labels resulting from labeling image objects according to some embodiments of the present disclosure.

FIG. 5 is a schematic diagram of an example of to-be-adjusted positions of labels resulting from labeling image objects according to some embodiments of the present disclosure.

### DETAILED DESCRIPTION OF EMBODIMENTS

The following description of the various embodiments is provided to illustrate the specific embodiments of the present disclosure. Furthermore, directional terms mentioned in the present disclosure, such as upper, lower, top, bottom, front, rear, left, right, inner, outer, side, surrounding, central, horizontal, lateral, vertical, longitudinal, axial, radial, uppermost, and lowermost, which only refer to the direction of drawings. Therefore, the directional terms configured as above are for illustration and understanding of the present disclosure and are not intended to limit the present disclosure.

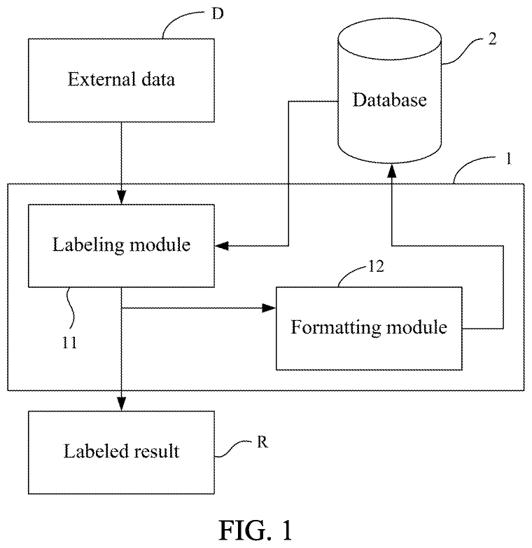

Please refer to FIG. 1, an aspect of the present disclosure that provides an image object labeling system, which can be configured to include a processing device 1 and a database 2. The processing device 1 includes a labeling module 11 and a formatting module 12, which are coupled to each other. The coupling manner can be a coupling or connection method, such as wired connection, wireless transmission, and data exchange. The database 2 is coupled to the labeling module 11 and the formatting module 12. The labeling module 11 and the formatting module 12 can be software modules, hardware modules, or modules that are cooperatively operated by software and hardware. For example, the labeling module module 11 can be configured to have data input, processing, and output functions, such as data reading, calculation, and display, to generate a labeled result R based on an external data D. The formatting module 12 can be configured to have data format customization or conversion function. Furthermore, the database 2 can store a data set, such as used for data processing (e.g., training models used for machine learning).

For example, the image object labeling system can be configured to include a processor and a memory coupled to the processor, wherein the memory stores at least one instruction executed by the processor to perform an image object labeling method provided by another aspect of the present disclosure, which is illustrated as the following but is not limited here.

Another aspect of the present disclosure that provides an image object labeling method that is executed by a processor coupled to a memory and includes providing an image file, e.g., being converted from a document file; detecting at least one first object from the image file, and generating at least one graphic block and attribute thereof according to a first detection result; performing a binarization process on the image file, to present a first graphic feature on a region containing the graphic block in the image file and present a second graphic feature on the rest region, in the image file; combining the first detection result and a result of the binarization process, and filtering the image file through a plurality of masks whose are gradually reduced to show a plurality of separated graphic components on a portion of the first graphic feature until a number of the separated graphic components is the same as a number of the at least one graphic block; and assigning a label to each of the separated graphic components according to the attribute of the at least one graphic block, alternatively, outputting a message, receiving a command, and adjusting the at least one graphic block and attribute thereof as the label according to the command. The following examples illustrate the sample states that can be implemented to understand the relevant content, but not limited here.

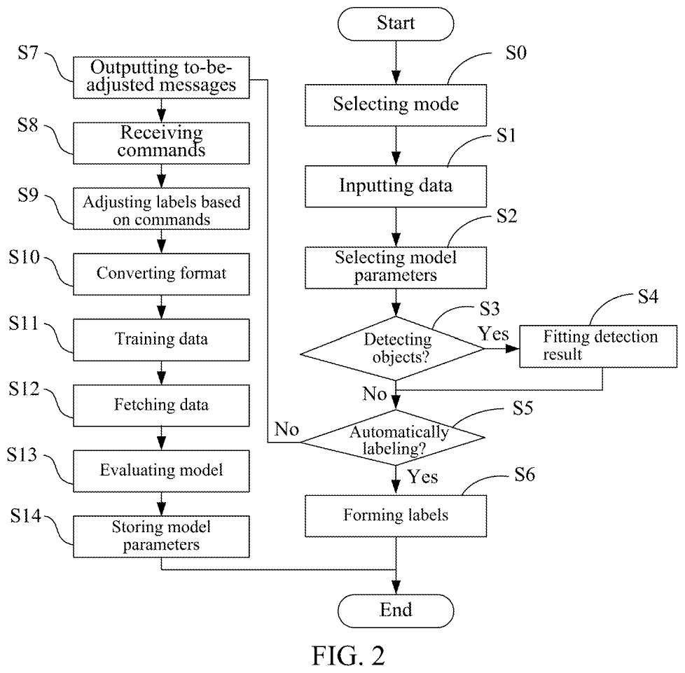

For example, as shown in FIG. 2, the image object labeling method may include steps S0 to S14. At least one part of these steps can be appropriately changed, simplified, or omitted based on actual applications to complete at least one part of the above method embodiment.

As shown in FIG. 2, step S0, may be configured to select operation modes, e.g., outputting a message (such as picture, light, and text), to instruct a user to select different operation modes, such as an auto-labeling mode and a label-adjusting mode, as a basis for follow-up operations.

As shown in FIG. 2, step S1, may be configured to input external data as a basis for subsequent label creation. For example, the external data is read. The external data can be an image file. For example, the image file can be provided as pre-filed and stored from a document file by an external machine, but not limited here.

The external data can also be the document file, and the processor can convert the document file to provide the image file. The image file is at least provided in the manner mentioned above and is not limited here. For example, the document file can be a digital document file containing various graphic examples, such as different electronic component views, and text examples, such as explanatory text. For example, “*. pdf,” a portable document format, e.g., the content of the file can include technical documents (datasheets) related to electronic components, but not limited here.

The digital document file can also be in other file formats, e.g., other file-formats, including graphics and text, such as “*.doc” or “*.odt.” Additionally, the external data can also include other data, such as tables. The image file can be in compressed or uncompressed file format, such as “*.jpg,” but it is not limited here. The image file can also be in other file formats, such as “*.png” or “*.bmp.”

The following image files can refer to file data or screen content in which data of the file is displayed on a display device and can also be called pictures. Subsequently, step S2 can be performed.

As shown in FIG. 2, step S2, may be configured to select model parameters, e.g., detecting at least one first object (such as graphic examples) from the image file, and generating at least one graphic block and attribute thereof according to a first detection result (i.e., a result of detecting the first object).

For example, values, words, pointers, signs, or a symbolic combination thereof can be used to represent the first object. For example, in the process of object detection, object classification, and block recognition, data can be trained according to the application context of the data to be labeled, and matching a machine learning model and parameters can be selected.

For example, the object detection method can be a method based on a deep learning model, such as real-time object detection (You only look once Version 3: Unified, Real-Time Object Detection, or YoloV3, in short), efficient and accurate scene text detection (EAST), convolutional neural network (CNN), and region-based CNN (R-CNN), in which setting 5 model features (such as architectures and parameters) can be understandable by those skilled in the art, and is not described here.

For example, the graphic block can be a partial feature diagram of an electronic component, e.g., a view of the electronic component. The attribute of the graphic block is configured as a view direction, such as top, bottom, long-side, short-side, pattern and/or section, but is not limited here.

For example, the above method, after generating a plurality of graphic blocks and their attribute according to the detection result, further includes detecting a plurality of second object (such as text examples) from the image file, and generating a plurality of text blocks and their attribute according to a second detection result (i.e., a result of detecting the second object). For example, values, words, pointers, signs, or a symbolic combination thereof can be used to represent the second object. For example, the second object detection method can be a method based on a deep learning model, such as YoloV3, EAST, CNN, and R-CNN. Subsequently, step S3 can be performed.

Optionally, as shown in FIG. 2, step S3, may be configured to determine whether an application scenario is used for object detection. If yes, step S4 can be performed, else step S5 can be performed.

As shown in FIG. 2, step S4, which is an object appearance fitting process, in which the object detection result will be fitted onto appearance positions of a to-be-labeled object. For example, a binarization process is performed on the image file to present a first graphic feature (e.g., being shown in black color) is presented on a region containing the graphic block in the image file and present a second graphic feature (e.g., being shown in white color) on the rest region, in the image file. For example, the image file can be pre-processed, e.g., by binarized, expansion, and erosion processes on pictures.

For example, the binarization process can be that the pictures are directly processed in the binaried process, but are not limited here, e.g., the pictures can be processed in a process of converting into grayscale, such as by an adaptive grayscale algorithm, and then be processed in the binaried process. In addition, the pictures can be expanded and eroded by expansion and erosion algorithms, which can be understandable by those skilled in the art, and are not described here.

In this example, a scheme of grayscale and binarization can be adopted. After a picture is pre-processed by the binaried process, the erosion algorithm (e.g., using one 13×13 mask) can be adopted to erode a part of the picture showing in white color, such that a part of the picture showing non-background contents (such as pixels of a partial feature of an electronic component) outwardly expands. Thus, object extraction effect can be improved.

Subsequently, several gradually reduced masks (e.g., using 13×13, 11×11, 9×9, 7×7, 5×5, 3×3 masks, in sequence) for filtering the image file, so that the contents of the image file are gradually and clearly shown.

For example, the pictures with the above detection result (such as only the first detection result or combining the first and second detection results) and the pre-processed in the binarization process can be combined to further narrow the range of object determination. Also, the range of objects can be defined in a filling manner, such as region filling algorithm or flood filling algorithm, which can be understandable by those skilled in the art, and is not described here.

Subsequently, the masks are gradually reduced for filtering. For example, the ranges of defined objects are connected to each other, so an erosion degree of the objects can be re-adjusted, e.g., first adjusting one mask into 11×11 for initial separation and calculation of a plurality of graphic components. In order to facilitate identification, the separated graphic components can be applied to the attributes of the graphic blocks (such as painted in different colors) generated according to the object detection results to avoid confusion. Then, the mask can be gradually reduced to make a part of the image file presenting the first graphic feature show the separated graphic components until the number of the separated graphic components and the number of the graphic blocks are the same. This step can be stopped to use these separated graphic components as targets that are to be labeled.

As shown in FIG. 2, step S5, may be configured to determine whether the operation mode is the auto-labeling mode. If yes, then performing a labeling process, such as step S6, else, performing an adjusting process.

For example, step S6, may be configured to give a label to each of the separated graphic components according to the attribute of the at least one graphic block. For example, a size of the mask is adjusted to absolutely separate the graphic components. When the number of the separated graphic components is the same as the number of the at least one graphic block, the attribute of the at least one graphic block (such as a category result detected from one graphic block object) is correspondingly applied to the graphic member as the label. The label can be presented as a form of a digital file, but is not limited here. For example, different labels can be presented in different colors fitted at a position corresponding to the respective graphic member to avoid visual confusion.

In another aspect, for example, the adjusting process may be configured to output message and receiving a command, and adjusting the at least one graphic block and attribute thereof as the label according to the command. Examples are as follows.

For example, as shown in FIG. 2, step S7 may be performed as configured to output a to-be-adjusted message, such as “the position of object to be adjusted,” “the range of object to be adjusted,” and/or “the category of object to be adjusted,” by the image object labeling system, to prompt a user to input a corresponding adjustment command for adjusting the attribute or feature of the graphic blocks, but is not limited here. This manner is also suitable for a process of adjusting the attribute or feature the text blocks. Subsequently, step S8 can be performed.

As shown in FIG. 2, step S8, may be configured to receive the adjustment command, such as “adjusting the position of object,” “adjusting the length of object,” “adjusting the width of object,” and/or “adjusting the name of category,” by the image object labeling system, as a basis for adjusting the attribute or feature of the graphic blocks (also applicable to the text blocks). Subsequently, step S9 can be performed.

As shown in FIG. 2, step S9, may be configured to adjust the graphic block and attribute thereof as the label according to the command. For example, the label is adjusted according to the adjustment command by the image object labeling system to update information (or data) belonging to the label to form a more accurate label of the object, which can be served as training data of a machine learning model. Subsequently, step S10 can be performed.

Optionally, as shown in FIG. 2, step S10, may be configured to format the training data. For example, a digital file containing the label can be precisely converted into a specified format required by the machine learning model. The format can be formed as a combination of different fields, texts, and values, according to actual application requirements, and is not limited here. Subsequently, step S11 can be performed.

Optionally, as shown in FIG. 2, step S11, may be configured to train a data set. For example, a digital file storing a specific format of a machine learning model and a file containing original digital data can be formed into new training data. Subsequently, step S12 can be performed.

Optionally, as shown in FIG. 2, step S12, may be configured to fetch the training data. For example, the training data can be fetched from the trained a data set to form digital data for adjusting the machine learning model. Subsequently, step S13 can be performed.

Optionally, as shown in FIG. 2, step S13, may be configured to evaluate a model. For example, adjustment results of the machine learning model can be evaluated to serve as a basis for training data or storing parameters. Subsequently, step S14 can be performed.

Optionally, as shown in FIG. 2, step S14, may be configured to perform another data set training process and storing parameters of a machine learning model.

Optionally, in one embodiment, after generating at least one graphic block and attribute thereof according to a first detection result, the method further includes: detecting at least one second object from the image file, and generating at least one text block and attribute thereof according to a second detection result. In this way, the text block and attribute thereof can be used to exclude the graphic block and attribute thereof to avoid misrecognition of the graphic block and attribute thereof, which can improve the labeling performance of image objects.

Optionally, in another application scenario, if the graphic block derived from the first object and the text block derived from the second object need to be combined, a relationship between the graphic block and the text block can be created. After the graphic components are cut, the graphic block, the attribute of the graphic block, the text block, and the attribute of the text block can be fetched in the graphic components to improve performance of labeling image objects.

Optionally, in one embodiment, the method further includes: processing the at least one graphic block and the at least one text block by a filling algorithm. In this way, results of the binaried pre-processing and the object detection can be effectively combined to improve performance of labeling image objects.

Optionally, in one embodiment, before performing the binarization process, the method further includes: performing a grayscaling process on the at least one graphic block and the at least one text block. In this way, the grayscale operation can be used to effectively increase identification of the content of the image file to avoid residual noise of the image file and to improve object matching degree of the binarization operation and performance of labeling image objects.

Optionally, in one embodiment, the method further includes: processing the resion presenting the second graphic feature by a dilation algorithm or an erosion algorithm. In this way, a certain processing effect can be provided under a condition of good use of computing resources to improve performance of labeling image objects.

Optionally, in one embodiment, the label includes a pattern, a text, or a combination thereof. In this way, breadth of the labels can be can enriched to meet the needs of data processing or display applications, so as to adjust or confirm contents of the labels to improve performance of labeling image objects, integrity of labeled image objects, and reusability of labeled image objects.

Optionally, in one embodiment, the at least one graphic block includes a partial feature diagram of an electronic component, and the attribute of the graphic block includes a directional attribute. In this way, automatic labeling operations can be performed for data that requires a large amount of processing (such as digital document files of electronic components) to improve the efficiency of labeling image objects.

To enable a person to understand the features of embodiments of the present disclosure, the following is an example of inputting a technical file (datasheet) of an electronic component as a document file and illustrates the classification process of the objects in the above embodiments. Still, it is not intended to be used as a limit.

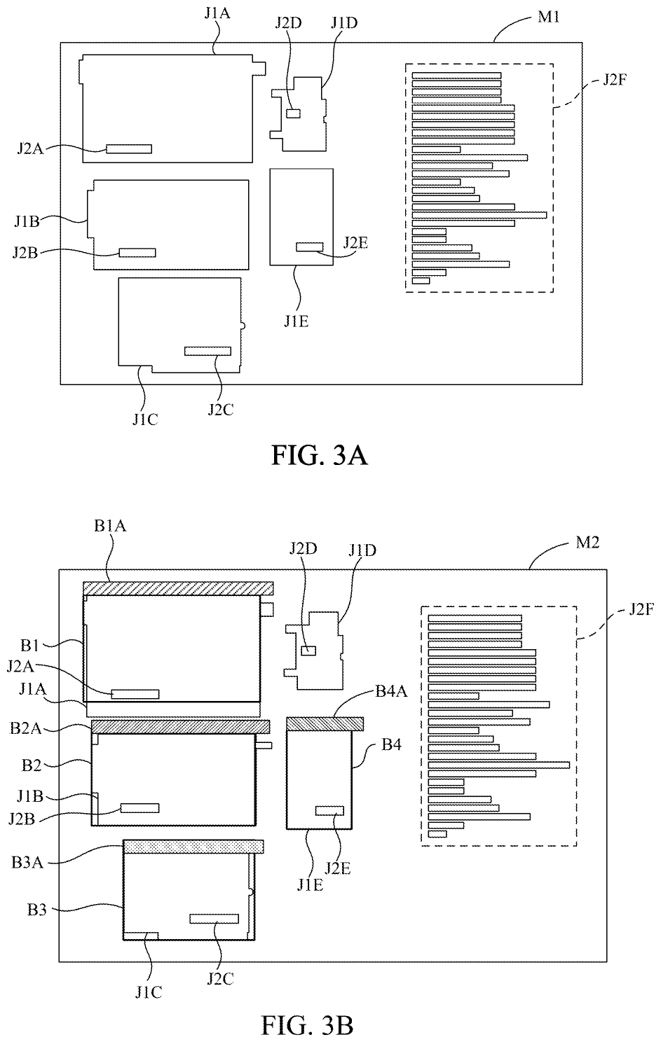

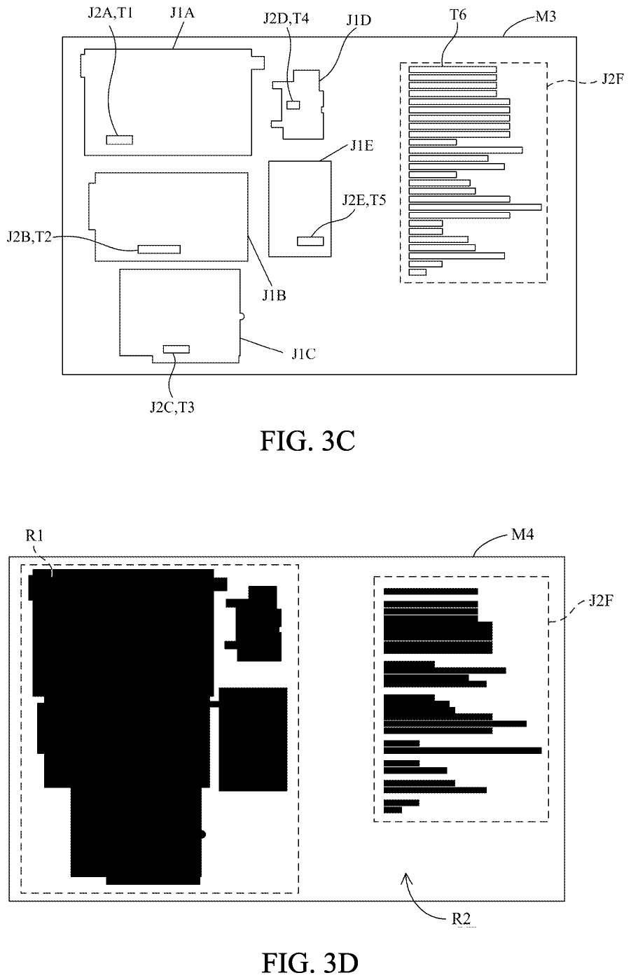

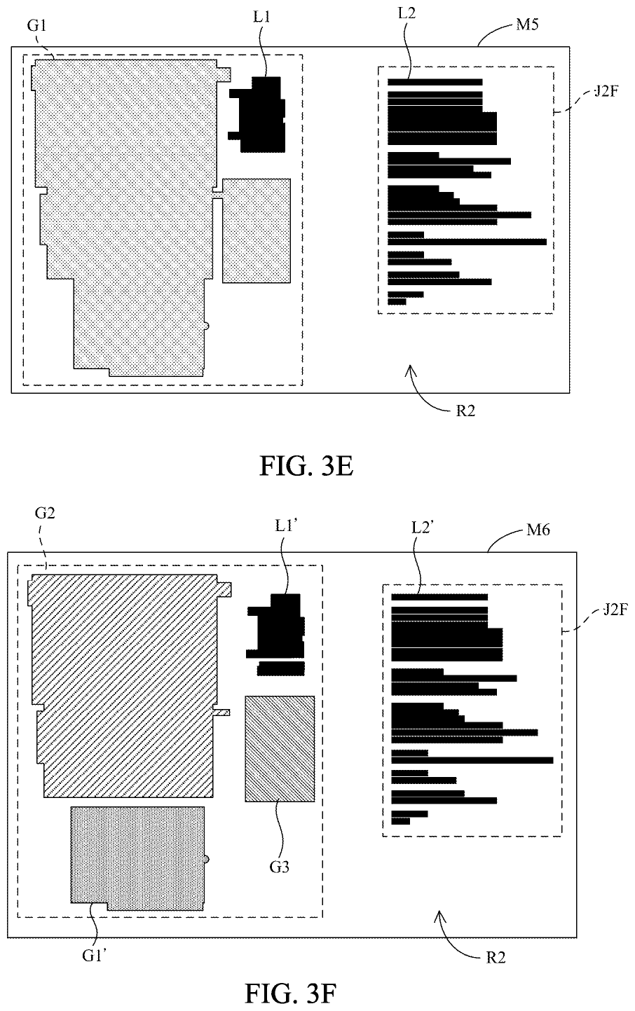

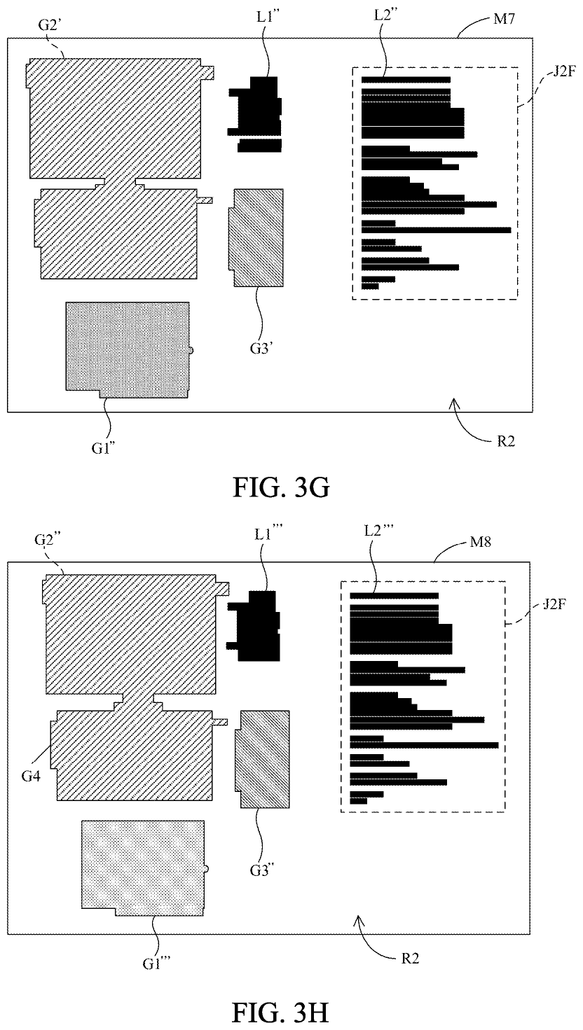

For example, as shown in FIG. 3A, in which a document file is converted into an image file M1, which can be displayed as containing many graphic examples J1A, J1B, J1C, J1D, J1E, and many text examples J2A, J2B, J2C, J2D, J2E, J2F. These graphic examples J1A, J1B, J1C, J1D, and J1E can be different views of the same electronic component, such as one of top, bottom, long-side, short-side, pattern, and section. In addition, these text examples J2A, J2B, J2C, J2D, J2E, and J2F can be displayed as explanation texts for the graphic examples J1A, J1B, J1C, J1D, and J1E. These graphic examples and text examples can be used as objects to be detect later.

Subsequently, as shown in FIG. 3B, in which another image file M2 is generated after the contents of the image file M1 are processed by a process of detecting objects of graphic examples. The image file M2 can be displayed as graphic blocks B1, B2, B3, and B4 (i.e., totally four graphic blocks) generated at the graphic examples J1A, J1B, J1C, and J1E, respectively. For example, the graphic blocks B1, B2, B3, and B4 can be displayed as different colored boxes with green, cyan, blue, and red colors for easy identification, but are not limited here. The graphic blocks B1, B2, B3, and B4, have a respective attribute block B1A, B2A, B3A, and B4A, which can be displayed in different colors and texts. For example, the attribute block B1A can be displayed as “Conn_DVI_LONGSide 1.00” by black fonts on a green background. Further, the attribute block B2A can be displayed as “Conn_DVI_Bottom 1.00” by black fonts on a cyan background. Further, the attribute block B3A can be displayed as “Conn_DVI_Pattern 0.93” by black fonts on a blue background. Further, the attribute block B4A can be displayed as “Conn_DVI_ShortSide 1.00” by black fonts on a red background.

Subsequently, as shown in FIG. 3C, in which another image file M3 is generated after the contents of the image file M1 are processed by a process of detecting objects of text examples. The image file M3 can be displayed as text blocks T1, T2, T3, T4, T5, and T6 generated at the text examples J2A, J2B, J2C, J2D, J2E, and J2F, respectively.

Subsequently, as shown in FIG. 3D, in which another image file M4 is generated after the contents of the image file M1 are pre-processed by a binarization process. The image file M4 can be displayed as a first graphic feature (e.g., in black color) in many regions R1 and a second graphic feature (e.g., in white color) in the remaining region R2. Then, the erosion algorithm (such as one 13×13 mask) can be used to outwardly expand a part of the picture with non-background contents (such as pixels of a partial feature of an electronic component).

Subsequently, as shown in FIG. 3E, in which another image file M5 is generated after combining the results of the object detection and the binaried process, to further narrow the range of object determination. In addition, a filling algorithm is used to define the range of objects. The image file M5 can be displayed as a single graphic member G1 (e.g., marked as blue color, totally one graphic member), and two first graphic feature ranges L1 and L2 (within a range marked as J2F). It should be noted that the first graphic feature ranges L1 is excluded from a range of labels to be given.

Subsequently, as shown in FIG. 3F, in which another image file M6 is generated by filtering the contents of the above image file M5 with a smaller (11×11) mask to re-adjust the erosion degree of the objects. The image file M6 can be shown as a form of gradually separating a plurality of graphic components G1′, G2, and G3 (i.e., totally three graphic components) and two first graphic feature ranges L1′ and L2′ (within the range marked as J2F).

Subsequently, as shown in FIG. 3G, in which another image file M7 is generated by filtering the contents of the above image file M6 with several smaller (9×9 and 7×7) masks in sequence to re-adjust the erosion degree of the objects. The image file M7 can be shown as a form of gradually separating a plurality of graphic components G1″, G2′, and G3′ (i.e., totally three graphic components) and two first graphic feature ranges L1″ and L2″ (within the range marked as J2F). In this phase, there are only three graphic components, which does not match four that is the number of graphic blocks, so continue to narrow the mask to further separate the graphic components.

Subsequently, as shown in FIG. 3H, in which another image file M8 is generated by filtering the contents of the above image file M7 with a smaller (5×5) mask to re-adjust the erosion degree of the objects. The image file M8 can be shown as a form of gradually separating a plurality of graphic components G1′″, G2″, G3″, and G4 (i.e., totally four graphic components). In this phase, there are four graphic components, which match four that is the number of graphic blocks, so no need to narrow the mask and separate the graphic components. The process can be ended.

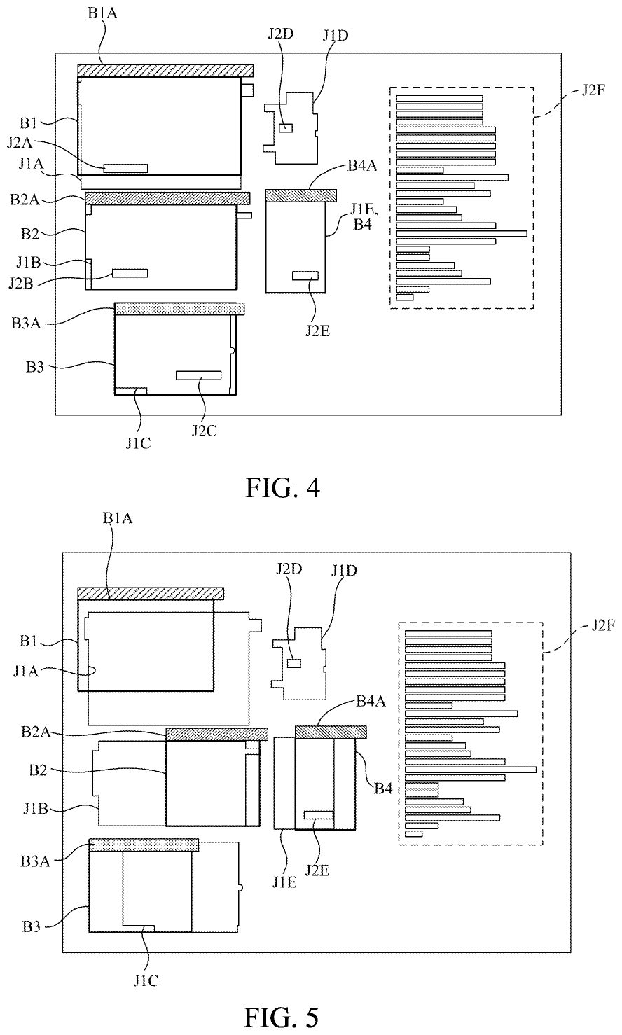

Furthermore, because distributions of objects in various documents are different, so matching degrees between the labels and the objects corresponding to various documents are different. The above content is taken as an example. Suppose there is an image file with similar content to the image file shown in FIG. 3A. In this case, the graphic blocks B1, B2, B3, and B4 (i.e., totally four graphic blocks) are generated at the graphic examples J1A, J1B, J1C, and J1E, respectively. Such that many ideal labels can be generated (as shown in FIG. 4). In another aspect, suppose there is an image file with similar content to the image file shown in FIG. 3A. In this case, if distributions of objects in various documents are different, e.g., the distribution of objects is too complex, concentrated, or biased, from the above case, resulting in the labels are still in a situation to be adjusted. Then, the above-mentioned adjustment process can be used.

In another aspect, the present disclosure further provides an image object labeling system, which includes a processor coupled to a memory storing instructions configured to be executed by the processor to perform the above image object labeling method.

For example, the image object labeling system can be configured as an electronic device with data processing functions. The electronic device can be cloud platform machines, servers, desktop computers, notebook computers, tablets, or smartphones, but is not limited here, to perform the above image object labeling method, which is described as above and is not described here.

In another aspect, the present disclosure further provides a tangible, non-transitory, computer readable medium, storing instructions that cause a computer to execute operations including: providing an image file; detecting at least one first object from the image file, and generating at least one graphic block and attribute thereof according to a first detection result; performing a binarization process on the image file, to present a first graphic feature is presented on a region containing the graphic block in the image file and present a second graphic feature on the rest region, in the image file; combining the first detection result and a result of the binarization process, and filtering the image file through a plurality of masks whose are gradually reduced to show a plurality of separated graphic components on a portion of the first graphic feature until a number of the separated graphic components is the same as a number of the at least one graphic block; and assigning a label to each of the separated graphic components according to the attribute of the at least one graphic block, alternatively, outputting a message, receiving a command, and adjusting the at least one graphic block and attribute thereof as the label according to the command.

After the instructions are loaded and executed by the computer, the computer can execute the above-mentioned image object labeling method. For example, the tangible, non-transitory, computer readable medium may contain several program instructions, which can be implemented by using existing programming languages to implement the above-mentioned image object classification methods, such as Python combining with Numpy, Matplotlib, and TENSORFLOW packages, but not limited here.

In another aspect, the present disclosure further provides a computer-readable medium, such as an optical disc, a flash drive, or a hard disk, but not limited here. It should be understandable that the computer-readable medium can further be configured as other forms of computer data storage medium, e.g., cloud storage (such as ONEDRIVE, GOOGLE Drive, AZURE Blob, or a combination thereof), or data server, or virtual machine. The computer can read the program instructions stored in the computer-readable medium. After the computer loads and executes the program instructions, the computer can complete the above-mentioned image object labeling method.

In summary, the image object labeling method, system, and tangible non-transitory computer readable medium of the present disclosure are provided for providing an image file; detecting at least one first object from the image file, and generating at least one graphic block and attribute thereof according to a first detection result; performing a binarization process on the image file, to present a first graphic feature is presented on a region containing the graphic block in the image file and present a second graphic feature on the rest region, in the image file; combining the first detection result and a result of the binarization process, and filtering the image file through a plurality of masks whose are gradually reduced to show a plurality of separated graphic components on a portion of the first graphic feature until a number of the separated graphic components is the same as a number of the at least one graphic block; and assigning a label to each of the separated graphic components according to the attribute of the at least one graphic block, alternatively, outputting a message, receiving a command, and adjusting the at least one graphic block and attribute thereof as the label according to the command. Thus, after the label creation process mentioned above, the image objects are labeled. It can greatly shorten creation time of labeling objects, and is beneficial to improve the label construction efficiency of the data set for the development and application of the machine learning model.

Although the present disclosure has been disclosed in preferred embodiments, which are not intended to limit the disclosure, those skilled in the art can make various changes and modifications without departing from the spirit and scope of the disclosure. Therefore, the scope of protection of the present disclosure is defined as definitions of the scope of the claims.

What is claimed is:

1. An image object labeling method, executed by a processor coupled to a memory, comprising:
providing an image file;
detecting at least one first object from the image file, and generating at least one graphic block and attribute thereof according to a first detection result;
performing a binarization process on the image file, to present a first graphic feature on a region containing the graphic block in the image file and present a second graphic feature on the rest region, in the image file;
combining the first detection result and a result of the binarization process, and filtering the image file through a plurality of masks whose are gradually reduced to show a plurality of separated graphic components on a portion of the first graphic feature until a number of the separated graphic components is the same as a number of the at least one graphic block; and
assigning a label to each of the separated graphic components according to the attribute of the at least one graphic block, alternatively, outputting a message, receiving a command, and adjusting the at least one graphic block and attribute thereof as the label according to the command.

2. The image object labeling method as claimed in claim 1, wherein after generating the at least one graphic block and attribute thereof, the method further comprises:
detecting at least one second object from the image file, and generating at least one text block and attribute thereof according to a second detection result.

3. The image object labeling method as claimed in claim 2, further comprising:
processing the at least one graphic block and the at least one text block by a filling algorithm.

4. The image object labeling method as claimed in claim 3, wherein before performing the binarization process, the method further comprises:
performing a grayscaling process on the at least one graphic block and the at least one text block.

5. The image object labeling method as claimed in claim 1, further comprising:
processing the region presenting the second graphic feature by a dilation algorithm or an erosion algorithm.

6. The image object labeling method as claimed in claim 1, wherein the label includes a pattern, a text, or a combination thereof.

7. The image object labeling method as claimed in claim 1, wherein the at least one graphic block includes a partial feature diagram of an electronic component, and the attribute of the graphic block includes a directional attribute.

8. An image object labeling system, comprising a processor coupled to a memory storing at least one instruction configured to be executed by the processor to perform a method comprising:
providing an image file;
detecting at least one first object from the image file, and generating at least one graphic block and attribute thereof according to a first detection result;
performing a binarization process on the image file, to present a first graphic feature on a region containing the graphic block in the image file and present a second graphic feature oh the rest region in the image file;
combining the first detection result and a result of the binarization process, and filtering the image file through a plurality of masks whose are gradually reduced to show a plurality of separated graphic components on a porting of the first graphic feature until a number of the separated graphic components is the same as a number of the at least one graphic block; and
assigning a label to each of the separated graphic components according to the attribute of the at least one graphic block, alternatively, outputting a message, receiving a command, and adjusting the at least one graphic block and attribute thereof as the label according to the command.

9. A tangible, non-transitory, computer readable medium, storing instructions that cause a computer to execute operations comprising:
providing an image file;
detecting at least one first object from the image file, and generating at least one graphic block and attribute thereof according to a first detection result;
performing a binarization process on the image file, to present a first graphic feature on a region containing the graphic block in the image file and present a second graphic feature on the rest region, in the image file;
combining the first detection result and a result of the binarization process, and filtering the image file trough a plurality of masks whose are gradually reduced to show a plurality of separated graphic components on a portion of the first graphic feature until a number of the separated graphic components is the same as a number of the at least one graphic block; and
assigning a label to each of the separated graphic components according to the attribute of the at least one graphic block, alternatively, outputting a message, receiving a command, and adjusting the at least one graphic block and attribute thereof as the label according to the command.
